(19) United States
(12) Patent Application Publication
(10) Pub. No.: US 2014/0077041 A1
(43) Pub. Date: Mar. 20, 2014

(54) DAMPING DEVICE FOR COVER OF CABLE ORGANIZATION BOX

(71) Applicant: LEGEND OFFICE CO., LTD., New Tiapei City (TW)

(72) Inventor: Chao-lin Chen, New Taipei City (TW)

(73) Assignee: LEGEND OFFICE CO., LTD., New Tiapei City (TW)

(21) Appl. No.: 13/623,869

(22) Filed: Sep. 20, 2012

(51) Int. Cl. F16L 3/26

(52) U.S. Cl. 248/49

(57) ABSTRACT

A cable organization box includes a box with two side panels, a cover, at least one link unit and at least one damping device. The cover is mounted to the box. The at least one link unit is a Z-shaped unit and located between the side panels and the cover. The first end of the at least one link unit is pivotably connected to the cover and the second end of the link unit is connected to the at least one damping device. The at least one damping device makes the cover to slowly close and quickly open relative to the box.

### BACKGROUND OF THE INVENTION

(1) Field of the Invention

The present invention relates to a damping device, and more particularly, to a damping device for slowly closing the cover and quickly opening the cover of a cable organization box.

(2) Description of the Prior Art

There are many office equipments such as computers, printers, telephones and internet devices installed in the office rooms, and the cables of these office equipments may usually hang along the desks and occupy a certain area of the floor. In order to organize the cables for the office equipments, metal cable organization boxes are developed.

However, when closing the cover to the organization box, a loud noise is generated because the cover drops to the box and the noise may affect the people in the office rooms. It is needed to improve the obvious shortcoming of the conventional cable organization boxes.

The present invention intends to provide a damping device which makes the cover to be slowly covered onto the box.

### SUMMARY OF THE INVENTION

The present invention relates to a cable organization box and comprises a box with two side panels, a cover, at least one link unit and at least one damping device. The cover is mounted to the box. The at least one link unit is a Z-shaped unit and located between the side panels and the cover. A first end of the at least one link unit is pivotably connected to the cover and a second end of the link unit is connected to the at least one damping device. The at least one damping device has a driving part which extends from a free end of the at least one link unit. The driving part has a toothed portion. A reception portion is connected to the side panel of the box and located corresponding to the driving part. The reception portion has a guide slot and a C-shaped slot. A damping member is engaged with the C-shaped slot and located corresponding to the toothed portion. One end of the damping member is fixed to the side panel of the box and the damping member has a base and a damping gear. The damping gear is connected to the base and engaged with the toothed portion.

Preferably, damping oil is filled between the base the damping gear.

Preferably, two lugs respectively extend from two ends of the base, one of the two lugs is slidably engaged with the guide slot and the other lug is connected to the side panel of the box.

Preferably, the reception portion is a C-shaped protrusion.

Preferably, the toothed portion is defined in the driving part and has multiple teeth.

Preferably, the at least one link unit has a spring connected thereto.

Only one of the two lugs of the damping member is fixed, so that when the cover is opened, the at least one link unit moves the damping member which does not interfere the upward movement of the at least one link unit to allow the cover to be quickly opened.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the damping device of the present invention is connected to a two-way cable organization box;

FIG. 2 is a cross sectional view to show the damping device of the present invention connected to the two-way cable organization box;

FIG. 3 is a cross sectional view to show the damping device of the present invention connected to the one-way cable organization box;

FIG. 4 is a cross sectional view to show that the damping device of the present invention connected to the two-way cable organization box, wherein the cover is opened;

FIG. 5 is a cross sectional view to show that the damping device of the present invention connected to the two-way cable organization box, wherein the cover is going to be closed;

FIG. 6 is a cross sectional view to show that the damping device of the present invention connected to the one-way cable organization box, wherein the cover is opened, and

FIG. 7 is a cross sectional view to show that the damping device of the present invention connected to the one-way cable organization box, wherein the cover is going to be closed.

### DETAILED DESCRIPTION OF THE PREFERRED EMBODIMENT

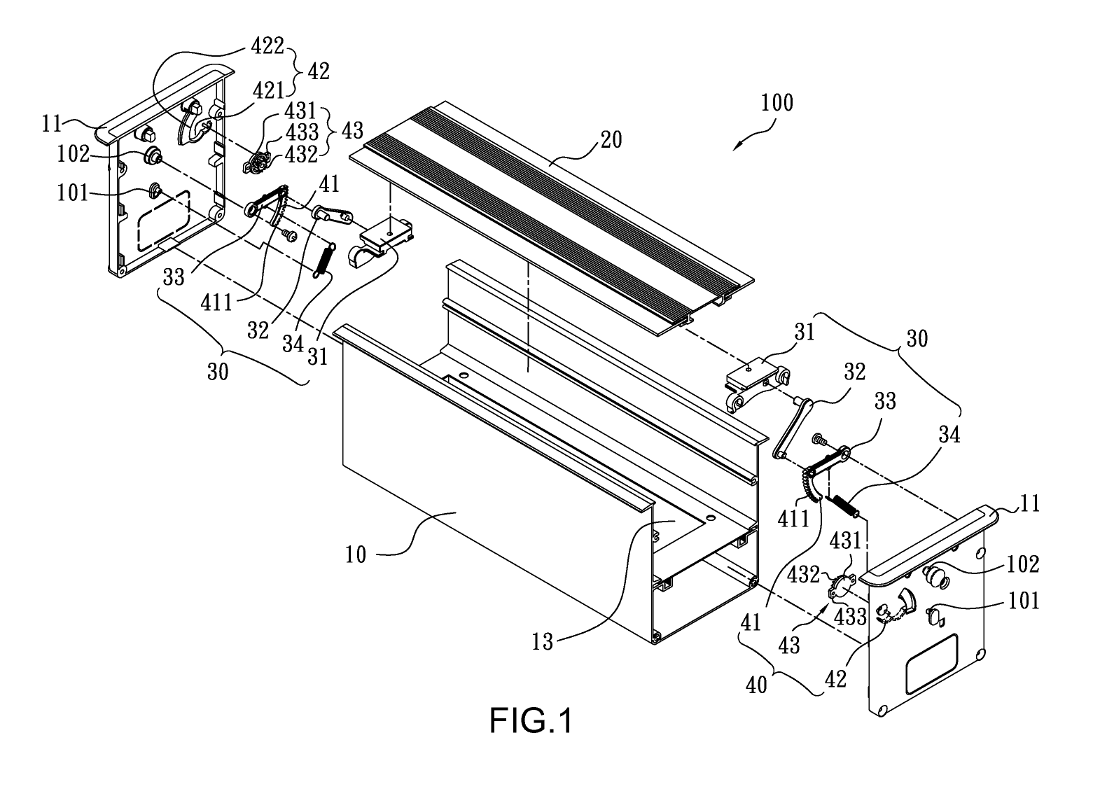

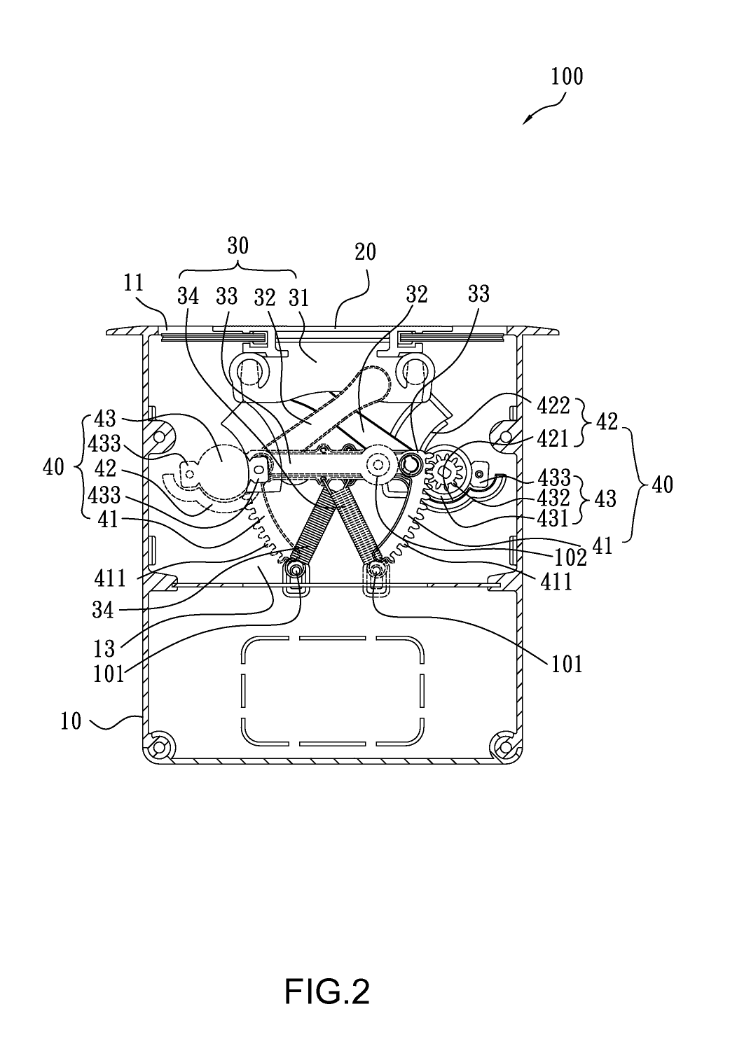

Referring to FIGS. 1 and 2, the damping device 40 of the present invention is used to a two-way cable organization box 100 which comprises a box 10, a cover 20, two link units 30 and two damping devices 40.

The box 10 has a space 13 and two side panels 11, each panel 11 has a fixing portion 101 and a pivotal portion 102.

The cover 20 is located above the space 13 so as to close the box 10.

The two link units 30 each are a Z-shaped unit and located between the side panels 11 and the cover 20. The first end of the each link unit 30 is pivotably connected to the cover 20. Each link unit 30 comprises a first link 31, a second link 32, a third link 33 and a spring 34. The first link 31 has one end connected to the cover 20 and the other end of the first link 31 is pivotably connected to one end of the second link 32. The other end of the second link 32 is pivotably connected to one end of the third link 33 and the other end of the third link 33 is pivotably connected to the pivotal portion 102 of the side panel 11. The first, second and third links 31, 32, 33 are pivotably connected to each other and form a Z-shaped link unit. The spring 34 is connected between the third link 33 and the fixing portion 101 of the side panel 11.

The two damping devices 40 are located alternatively to each other and each have a driving part 41, a reception 42 and a damping member 43. The driving part 41 extends from the free end of the third link 33 and has a toothed portion 411. In this embodiment, the toothed portion 411 is defined in the driving part 41 and has multiple teeth.

The reception portion 42 is connected to the side panel 11 of the box 10 and located corresponding to the driving part 41. In this embodiment, the reception portion 42 is a C-shaped protrusion and has a guide slot 422 and a C-shaped slot 421.

The damping member 43 is engaged with the C-shaped slot 421 and located corresponding to the toothed portion 411. One end of the damping member 43 is fixed to the side panel 11 of the box 10 and the damping member 43 has a base 431 and a damping gear 432. The damping gear 432 is connected to the base 431 and engaged with the toothed portion 411. Two lugs 433 respectively extend from two ends of the base 431, one of the two lugs 433 is slidably engaged with the guide slot 422.

By the specific arrangement of the damping device 40, the cover 30 is slowly closed and quickly opened.

Damping oil is filled between the base 431 and the damping gear 432 so as to generate damping function.

Only one of the two lugs 433 of the damping member 40 is fixed to the side panel 11 of the box 10 and the other lug 433 is slidably engaged with the guide slot 422, so that when the cover 20 is opened, the link units 30 moves the damping member 40 which does not interfere the upward movement of the link units 30 to allow the cover 30 to be quickly opened.

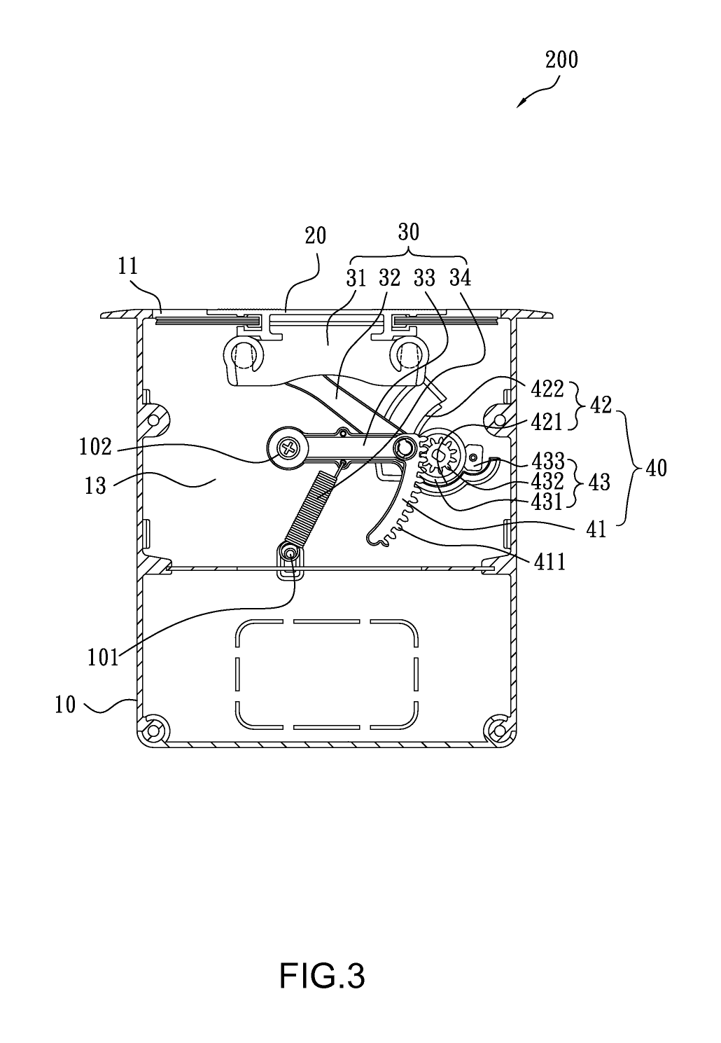

As shown in FIG. 3, the damping device 40 is used to a one-way cable organization box 200 which comprises a box 10, a cover 20, a link unit 30 and a damping device 40.

The box 10 has a space 13 and two side panels 11, one of the two panels 11 has a fixing portion 101 and a pivotal portion 102.

The cover 20 is located above the space 13 so as to close the box 10.

The link unit 30 is connected to one end of the cover 20 and located between the side panels 11 and the cover 20. The link unit 30 comprises a first link 31, a second link 32, a third link 33 and a spring 34. The first link 31 has one end connected to the cover 20 and the other end of the first link 31 is pivotably connected to one end of the second link 32. The other end of the second link 32 is pivotably connected to one end of the third link 33 and the other end of the third link 33 is pivotably connected to the pivotal portion 102 of the side panel 11. The first, second and third links 31, 32, 33 are pivotably connected to each other and form a Z-shaped link unit. The spring 34 is connected between the third link 33 and the fixing portion 101 of the side panel 11.

The damping device 40 has a driving part 41, a reception 42 and a damping member 43. The driving part 41 extends from the free end of the third link 33 and has a toothed portion 411. In this embodiment, the toothed portion 411 is defined in the driving part 41 and has multiple teeth.

The reception portion 42 is connected to the side panel 11 of the box 10. In this embodiment, the reception portion 42 is a C-shaped protrusion and has a guide slot 422 and a C-shaped slot 421.

The damping member 43 is engaged with the C-shaped slot 421 and located corresponding to the toothed portion 411. One end of the damping member 43 is fixed to the side panel 11 of the box 10 and the damping member 43 has a base 431 and a damping gear 432. The damping gear 432 is connected to the base 431 and engaged with the toothed portion 411. Two lugs 433 respectively extend from two ends of the base 431, one of the two lugs 433 is slidably engaged with the guide slot 422.

By the specific arrangement of the damping device 40, the cover 30 is slowly closed and quickly opened.

Damping oil is filled between the base 431 and the damping gear 432 so as to generate damping function.

Only one of the two lugs 433 of the damping member 40 is fixed to the side panel 11 of the box 10 and the other lug 433 is slidably engaged with the guide slot 422, so that when the cover 20 is opened, the link units 30 moves the damping member 40 which does not interfere the upward movement of the link units 30 to allow the cover 30 to be quickly opened.

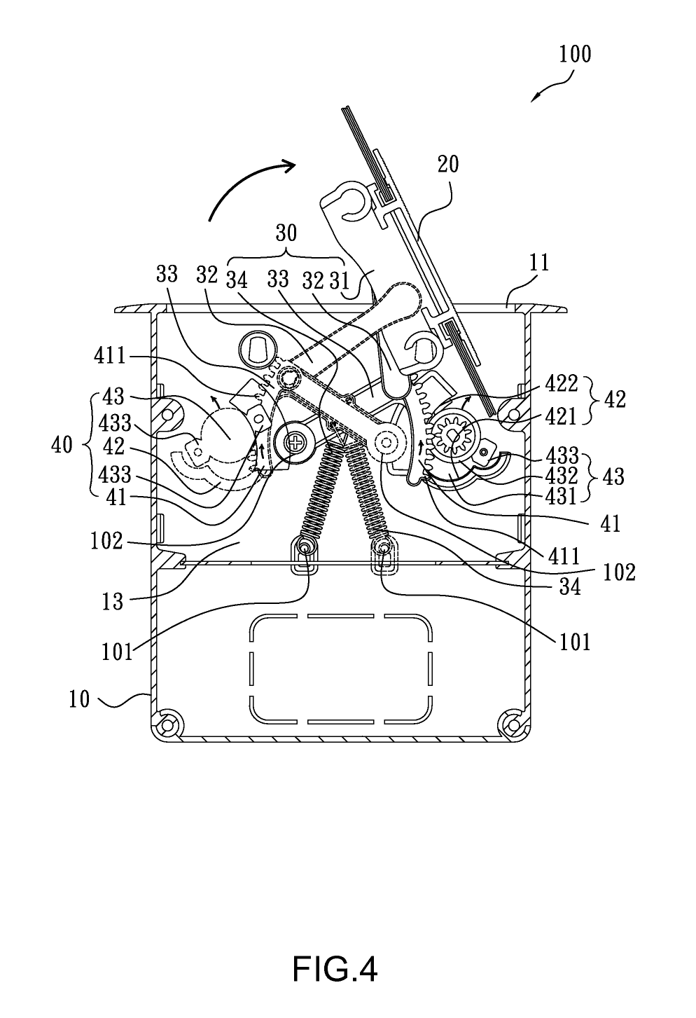

As shown in FIG. 4, when the cover 20 of the box 100 is opened, the cover 20 is pivoted and the opening side of the cover 20 is moved upward, so that the two link units 30 are moved upward. Because only one lug 433 is fixed to the side panel 11 and the other one lug 433 is movable, so that the link units 30 moves the damping member 40 which does not interfere the upward movement of the link units 30 to allow the cover 30 to be quickly opened.

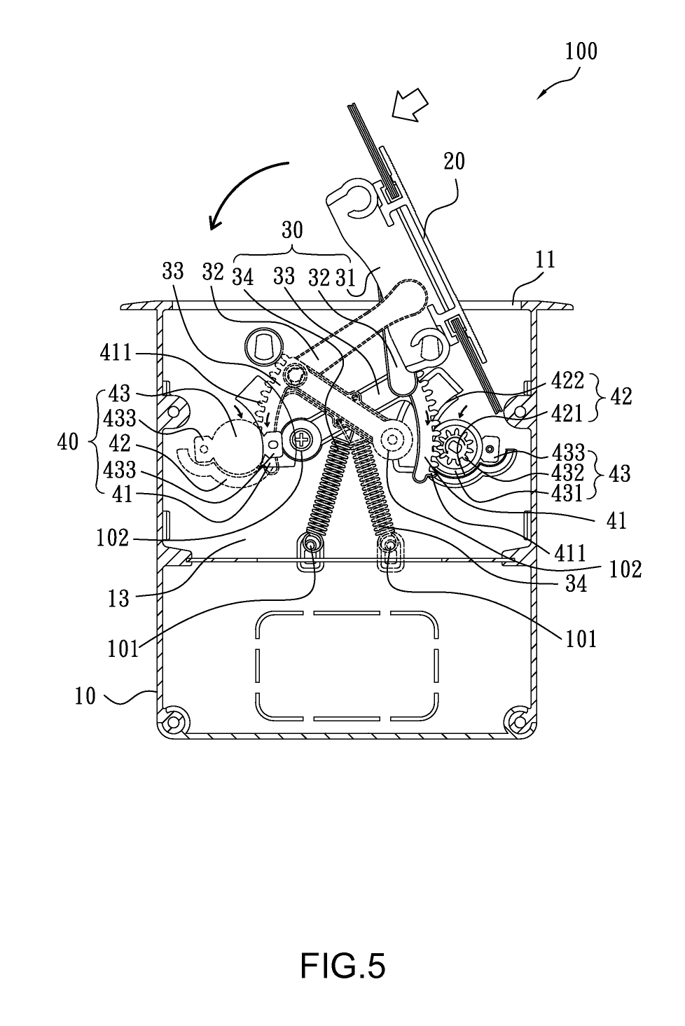

As shown in FIG. 5, when the cover 20 of the box 100 is to be closed, the cover 20 is pushed at the opening side of the cover 20 and the spring 34 pulls the cover 20 to close. The two link units 30 are moved downward and move the damping member 43 to the C-shaped slot 421, and the damping gear 432 is engaged with the toothed portion 411 to generate damping function to the link units 30. Therefore, the cover 20 is slowly closed.

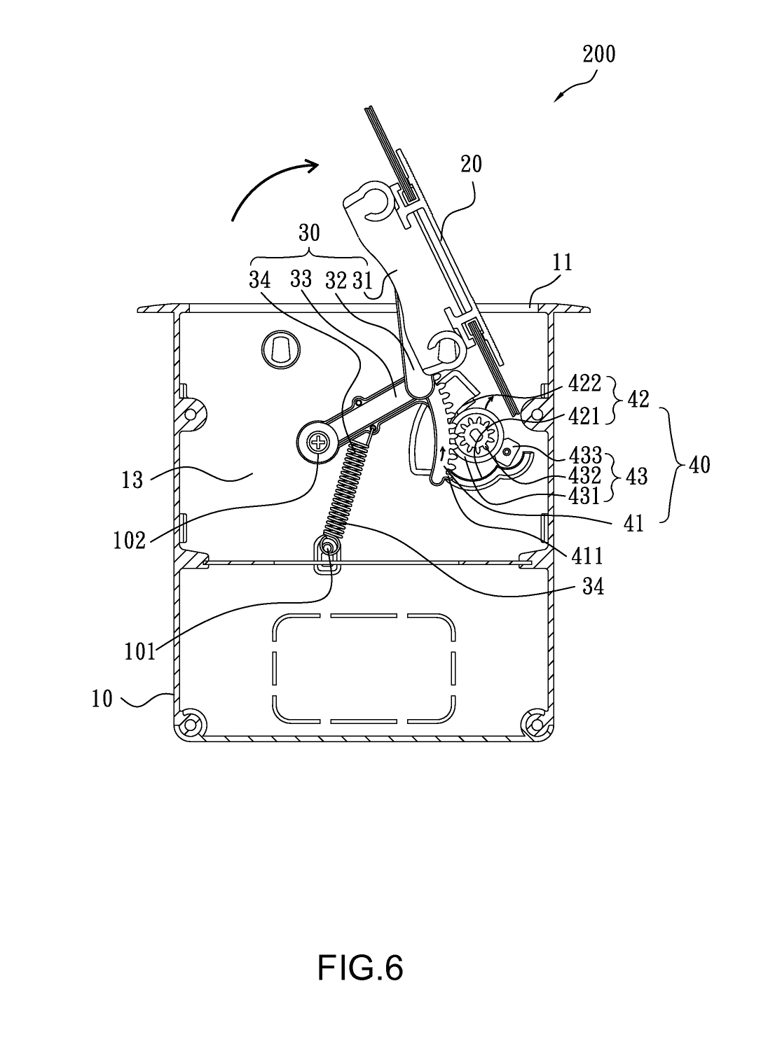

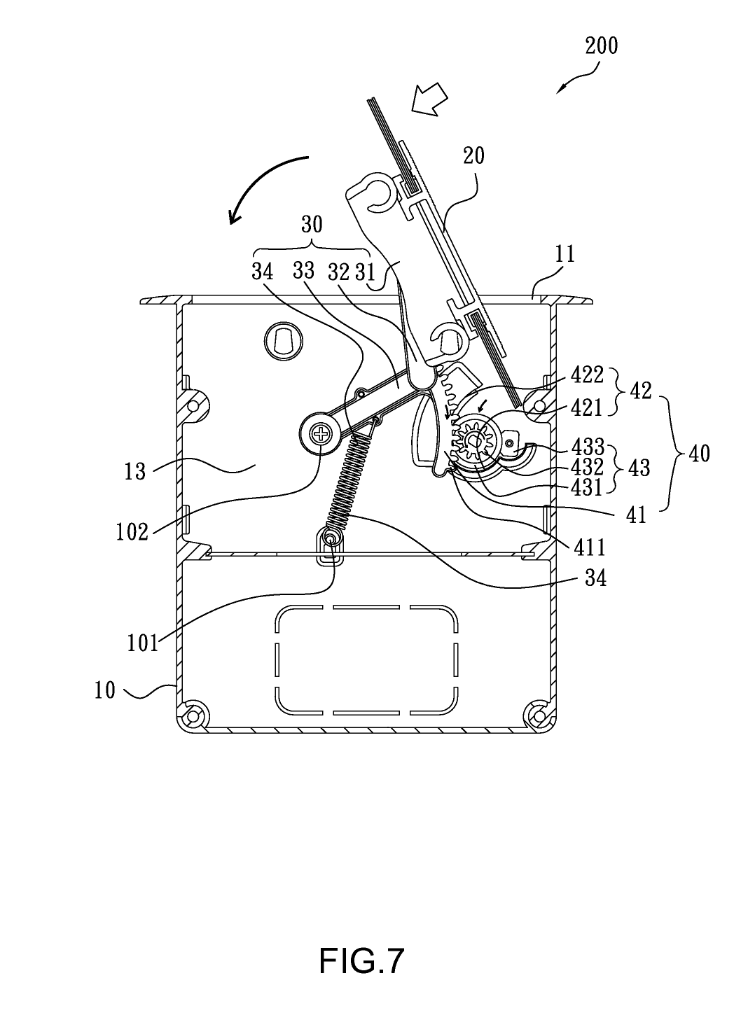

As shown in FIGS. 6 and 7, the opening of the cover 20 of the box 200 is similar to the previous embodiment and will not be described in detail. When the cover 20 of the box 200 is to be closed, the cover 20 is pushed at the opening side of the cover 20 and the spring 34 pulls the cover 20 to close. The link unit 30 is moved downward and moves the damping member 43 to the C-shaped slot 421, and the damping gear 432 is engaged with the toothed portion 411 to generate damping function to the link unit 30. Therefore, the cover 20 is slowly closed to the box 200.

While we have shown and described the embodiment in accordance with the present invention, it should be clear to those skilled in the art that further embodiments may be made without departing from the scope of the present invention.

What is claimed is:

1. A cable organization box comprising:
a box with two side panels, a cover, at least one link unit and at least one damping device, the cover being mounted to the box, the at least one link unit being a Z-shaped unit and located between the side panels and the cover, a first end of the at least one link unit pivotably connected to the cover and a second end of the link unit connected to the at least one damping device, the at least one damping device having a driving part which extends from a free end of the at least one link unit, the driving part having a toothed portion;
a reception portion connected to the side panel of the box and located corresponding to the driving part, the reception portion having a guide slot and a C-shaped slot, and
a damping member engaged with the C-shaped slot and located corresponding to the toothed portion, an end of the damping member fixed to the side panel of the box and the damping member having a base and a damping gear, the damping gear connected to the base and engaged with the toothed portion.

2. The cable organization box as claimed in claim 1, wherein damping oil is filled between the base the damping gear.

3. The cable organization box as claimed in claim 2, wherein two lugs respectively extend from two ends of the base, one of the two lugs is slidably engaged with the guide slot and the other lug is connected to the side panel of the box.

4. The cable organization box as claimed in claim 1, wherein the reception portion is a C-shaped protrusion.

5. The cable organization box as claimed in claim 1, wherein the toothed portion is defined in the driving part and has multiple teeth.

6. The cable organization box as claimed in claim 1, wherein the at least one link unit has a spring connected thereto.
